(19) United States
(12) Patent Application Publication
(10) Pub. No.: US 2009/0020511 A1
(43) Pub. Date: Jan. 22, 2009

(54) Ablation

(76) Inventors: Swaroop K. Kommera, Corvallis, OR (US); Richard J. Oram, Corvallis, OR (US); Siddhartha Bhowmik, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/879,416

(22) Filed: Jul. 17, 2007

(51) Int. Cl. B08B 7/00

(52) U.S. Cl. 219/121.68

(57) ABSTRACT

Embodiments of a method of ablation are disclosed.

### BACKGROUND

In laser ablation, machining solid material may be selectively removed from the solid mass at very small scales. Partially due to controllability, automation, and efficiency factors, laser ablation is used in many industrial applications, particularly semiconductor machining.

### BRIEF DESCRIPTION OF THE DRAWINGS

The accompanying drawings illustrate various embodiments of the principles described herein and are a part of the specification. The illustrated embodiments are merely examples and do not limit the scope of the claims.

FIG. 1 is a diagram of an embodiment of a system of laser ablation machining having no reflective coating, according to principles described herein.

FIG. 2 is a diagram of an embodiment of a machinable body having a trench formed therein by the system of FIG. 1.

FIG. 3 is a diagram of an embodiment of a system of laser ablation machining, according to principles described herein.

FIG. 4 is a diagram of an embodiment of a machinable body having a trench formed therein by the system of FIG. 4, according to principles described herein.

FIG. 5 is a diagram of a cross-sectional side view of a portion of an embodiment of an inkjet die having a trench formed therein, according to principles described herein.

FIG. 6 is a diagram of a cross-sectional side view of a portion of an embodiment of an inkjet die, according to principles described herein.

FIG. 7 is a diagram of an embodiment of a system of laser ablation machining, according to principles described herein.

FIG. 8 is a flowchart of an embodiment of a method of laser ablation machining, according to principles described herein.

Throughout the drawings, identical reference numbers designate similar, but not necessarily identical, elements.

### DETAILED DESCRIPTION

As mentioned above, lasers can be used for many purposes, including the controlled removal of material from a machinable body by heating the material to the point of evaporation or conversion to plasma. Laser ablation machining processes often include the use of an assist liquid or gas that is directed in or substantially near the path of a laser beam to help remove evaporated material or plasma produced by application of the laser from the machinable body.

However, in some cases, particles from the assist material may cause portions of laser beam pulses directed at a target area on the machinable body to deflect to an area of the machinable body not intended to receive ablation machining. These deflected pulses may remove material from unintended areas of the machinable body.

In some situations, the body being machined by laser ablation may be a layer of material disposed on a substrate, perhaps over other layers of material. Where this is the case, the laser beam may remove too much material from the body being machined and exhibit a “punch-through” effect in which layers of material under the body being machined are damaged by the laser beam.

Referring to FIG. 1, a typical system (100) of laser ablation machining for an inkjet die is shown. The system (100) includes a laser tool (110) that serves as a source for both an assist material (120) and laser beam pulses (145). The laser tool (110) is configured to selectively remove material from a semiconductor body (155) having a hard mask oxide layer (135) disposed on an upper surface. The laser beam pulses (145) are configured to penetrate the semiconductor body (155) to a certain depth and ablate material in the semiconductor body (155) up to that depth to form a trench (150) in the semiconductor body (155).

As shown, however, particles from the assist material (120) may deflect optical energy (130, 140) from one or more laser beam pulses (145) away from the intended trench location and onto other portions of the hard mask oxide layer (135), resulting in unintended ablation or damage to the hard mask oxide layer (135) and possibly to underlying material in the semiconductor body (155). Damage caused to the hard mask oxide layer (135) or semiconductor body (155) by the deflected optical energy (130, 140) may be exacerbated if one or more of the original regions of damage serves as a starting point for a crack or other defect in the hard mask oxide layer (135) or semiconductor body (155).

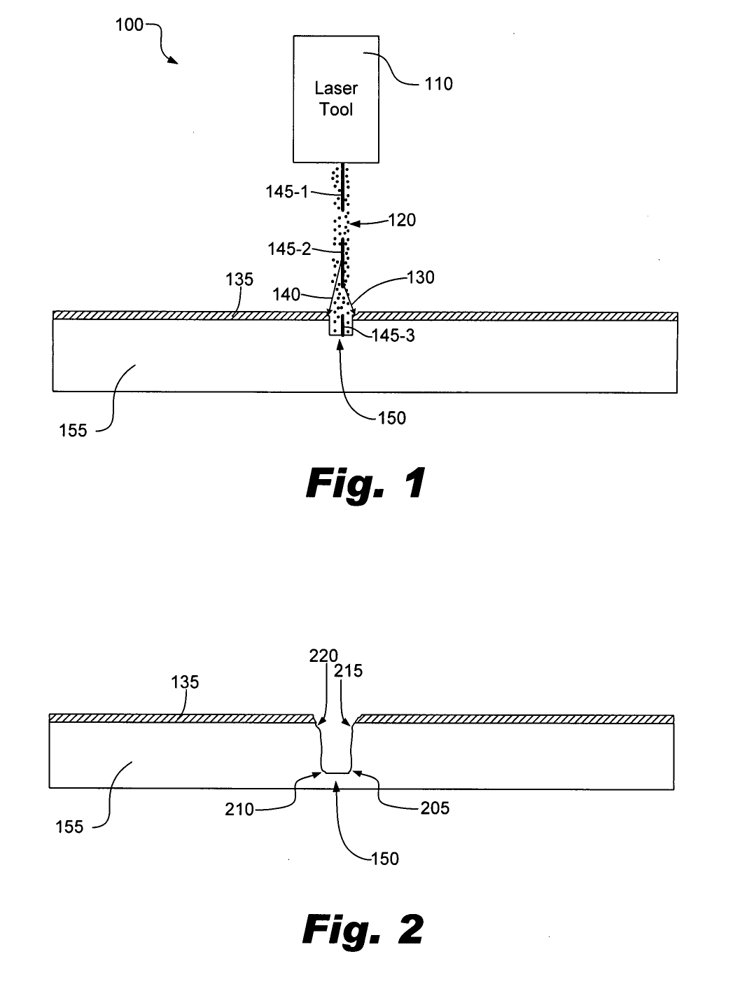

Referring now to FIG. 2, the semiconductor body (155) of FIG. 1 is shown after the ablation machining has been completed and the semiconductor body (155) has undergone additional processing. The damage to the hard mask oxide layer (135) from the deflected laser beam pulses (145) results in a wider than desired trench (150), particularly at the upper portion or mouth of the trench. The mouth of the trench (150) also has inconsistent and rounded corners (205, 210, 215, 220).

Therefore, it may be desirable to provide a system of laser ablation machining that reduces or eliminates unintended damage to a machinable body caused by deflected energy from an ablation beam, for example, from application of an assist material. It may also be desirable to provide a system of laser ablation machining that prevents “punch through” damage to underlying layers of a machinable body.

To accomplish these and other goals, the present specification discloses systems and methods of laser ablation machining that utilize machinable bodies having layers of reflective material. The layers of reflective material may protect portions of the machinable bodies from unintended ablation caused by ablation beams deflected by assist materials or other factors. Additionally, the reflective coatings may prevent underlying layers of the machinable bodies from unintended ablation.

As used in the present specification and in the appended claims, the term “ablation beam” refers to any beam of energy used to selectively ablate portions of a solid body.

As used in the present specification and in the appended claims, the term “laser ablation machining” refers to a process by which material is selectively removed from a body through vaporization or conversion to plasma, using controlled laser pulses or a controlled continuous laser beam.

As used in the present specification and in the appended claims, the term “assist material” refers to a material, liquid or gas, used in conjunction with an ablation beam, such as a laser beam, to facilitate the removal of material during ablation machining.

As used in the present specification and in the appended claims, the term “machinable body” refers to an object from which material may be removed by ablation machining.

In the following description, for purposes of explanation, numerous specific details are set forth in order to provide a thorough understanding of the present systems and methods. It will be apparent, however, to one skilled in the art that the present systems and methods may be practiced without these specific details. Reference in the specification to “an embodiment,” “an example” or similar language means that a particular feature, structure, or characteristic described in connection with the embodiment or example is included in at least that one embodiment, but not necessarily in other embodiments. The various instances of the phrase “in one embodiment” or similar phrases in various places in the specification are not necessarily all referring to the same embodiment.

The principles disclosed herein will now be discussed with respect to exemplary systems of ablation machining, exemplary machinable bodies, and exemplary methods of ablation machining.

### Exemplary Systems

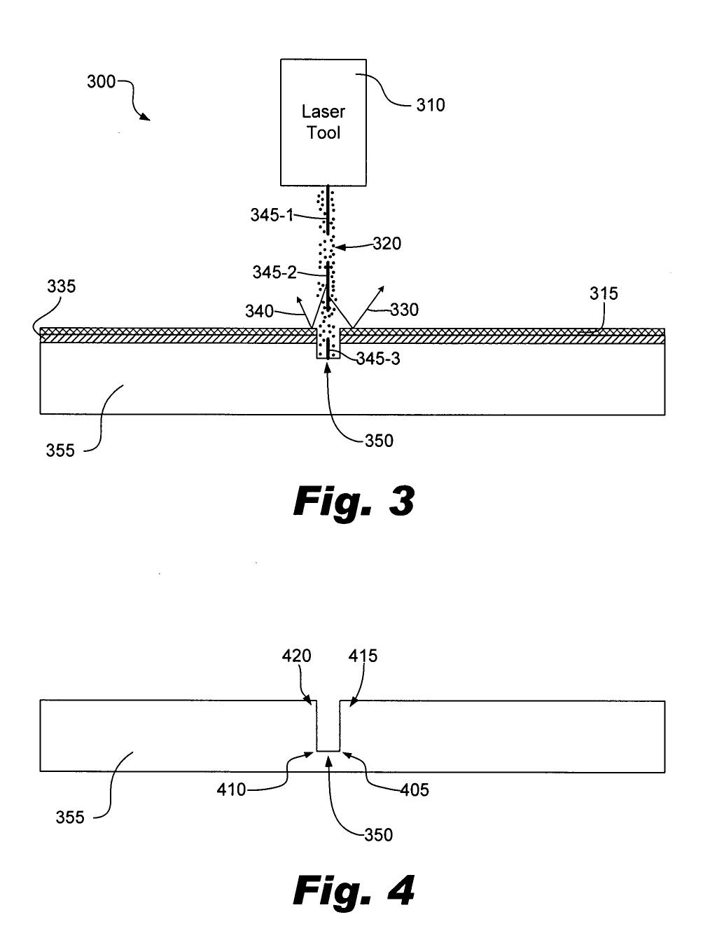

Referring now to FIG. 3, an exemplary system (300) for ablation machining is shown. The example of FIG. 3 is a system for laser ablation machining.

The exemplary system (300) includes a laser tool (310) and a machinable body (355) having a layer of reflective material (315) disposed over a hard mask oxide layer (335). The layer of reflective material (315) is present on areas of the machinable body (355) The laser tool (310) serves as a source for laser beam pulses (345) and an assist material (320). The laser beam pulses (345) are configured to remove material from selected portions of the machinable body (355) by heating the material to the point of vaporization or conversion to plasma. While in the example shown the material is removed by laser beam pulses (345), in other embodiments, it is conceivable that a continuous, precisely controlled laser beam may be used to remove the material from the machinable body (355).

In the present example, the laser tool (310) is directing laser beam pulses (345) and assist material (320) towards a specific region of the machinable body (355) to create a trench (350) in the machinable body. The assist material (320) is directed toward the machinable body (355) along the path of the laser beam pulses (345) and helps to remove vaporized material from the region of the machinable body (355) that is receiving and being ablated by the laser beam pulses (345) to form the trench (350). Furthermore, the continuous flow of assist material (320) from the laser tool (310) to this region may prevent dust or other particles from interfering with the interaction between the laser beam pulses (345) and the material of the machinable body (355). In some embodiments, the assist material (320) is a material, such as a noble gas, that will not easily react with other materials present during ablation.

However, as has been previously mentioned, particles from the assist material (320) may increase deflection of the optical energy (330, 340) from the laser beam pulses (345) to unintended areas of the machinable body (355) for which the laser machining is not used, or even desired. In many situations, deflection of laser beam pulses (345), or portions thereof, may occur irrespective of interference from an assist material. However, the amount and degree of deflection of optical energy (330, 340) from the laser beam pulses (345) may be directly affected by the type and/or amount of an assist material used in the ablation process.

The layer of reflective material (315) is disposed at least over areas for which protection from deflected optical energy (330, 340) is sought. In some examples, the layer of reflective material (315) may be uniformly disposed over most or all of the machinable body (355), except those portions that are to be ablated by the laser tool (310). In some embodiments, the reflective material (315) may be deposited widely over the body (355) and then selectively removed from those areas where ablation is to occur.

Once in place, the layer of reflective material (315) reflects any deflected optical energy (330, 340) away from protected portions of the machinable body (355), thus preventing the deflected optical energy (330, 340) from causing unintended ablation of the hard mask oxide layer (335) or the base material of the machinable body (355). As ablation may occur in a material that absorbs the laser beam pulses (345), as opposed to a material that reflects the laser beam pulses (345), the layer of reflective material (315) does not risk ablation or damage from the laser beam pulses (345). Because of this property, the layer of reflective material (315) may provide uniform and lasting protection from ablation damage in regions of the machinable body that are close to the desired region of ablation.

The layer of reflective material (315) may include a metal or metallic composition, such as aluminum or nickel, that is deposited directly on the oxide hard mask layer (335) by, for example, a sputtering process, an evaporation process, or the like. In other embodiments, the layer of reflective material (315) may be disposed directly on the base material of the machinable body (355).

Referring now to FIG. 4, the exemplary machinable body (355) of FIG. 3 is shown after subsequent processing and completion of the trench (350) formed in the machinable body (355) by the laser tool (310). In contrast to the trench (150, FIG. 2) shown in FIG. 2, having damage due to deflected optical energy (130, 140, FIG. 1) from the laser beam pulses (145, FIG. 1), the trench (350) of the present example maintains relatively regular corners (405, 410, 415, 420) and a uniform width.

As industries use semiconductor trenches of increasingly smaller widths and precise dimensions, semiconductor machinable bodies (355) having layers of reflective material (315) according to principles of the present specification may be used to accomplish this goal without compromising the quality of trenches (350) formed in the machinable bodies (355). Furthermore, by using a layer of reflective material (315) consistent with the principles of the present specification, the width of openings in the hard mask oxide layer (335) may be brought closer to the width of corresponding trenches (350) in the machinable body (355), without fear of damage to the hard mask oxide layer (335), and thus conserving valuable space on the machinable bodies (355).

### Exemplary Inkjet Die

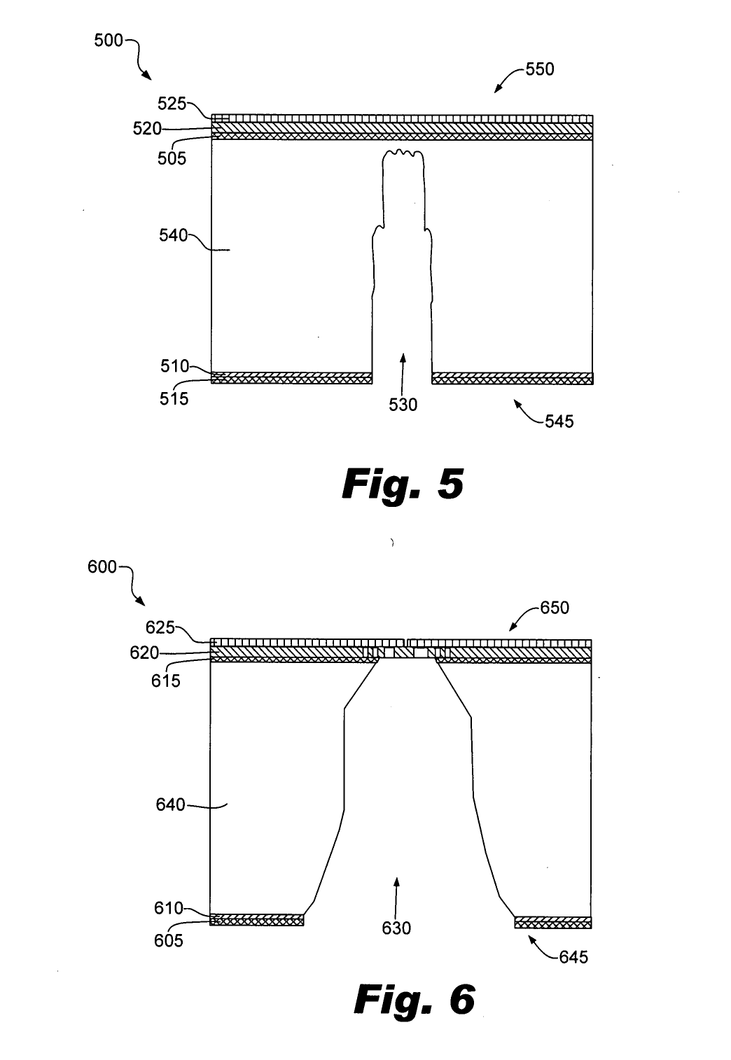

Referring now to FIG. 5, a cross-sectional side view of a portion of an exemplary inkjet die (500) is shown. The exemplary inkjet die (500) has first and second layers of reflective material (505, 515), consistent with the principles of the present specification, to prevent damage from a laser tool as a trench (530) for an ink nozzle is created in the exemplary inkjet die (500). The exemplary inkjet die (500) includes a semiconductor body (540) having a front side (550) and a back side (545). The exemplary inkjet die (500) is shown after having undergone laser ablation machining from a laser tool to form the ink nozzle trench (530).

The front side (550) includes a layer of front-side thin films (525), a layer of polymer fluidics (520), and the first layer of reflective material (505). Due to the fact that in the material is selectively removed from the semiconductor body (540) beginning at the back side (545) and moving toward the front side (550), the first layer of reflective material (505) prevents “punch through” damage from occurring to the layer of thin films (525) and the layer of polymer fluidics (520) on the front side (550).

The back side (545) of the exemplary inkjet die (500) includes the second layer of reflective material (515) and an oxide hard mask layer (510) according to the principles previously described. The second layer of reflective material (515) allows the hard mask oxide layer (510) opening to the ink nozzle trench to substantially match the width of the nozzle trench (530), formed by ablation, without resultant damage to the hard mask oxide layer (510).

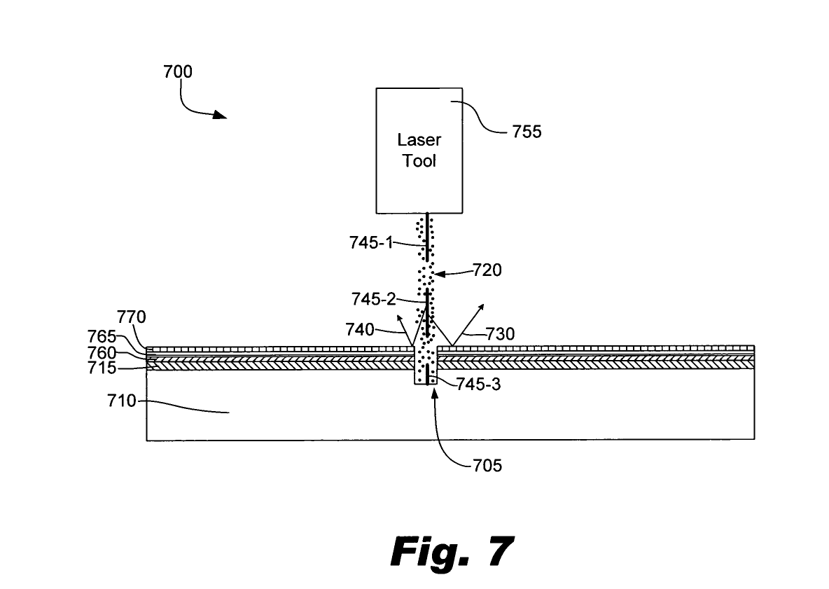

Referring now to FIG. 6, a cross-sectional side view of a portion of an exemplary inkjet die (600) is shown.

The exemplary inkjet die (600) includes a semiconductor body (640) having front and back sides (650, 645). The back side (645) includes a hard mask oxide layer (610) and a first layer of reflective material (605), according to principles described herein. The front side (650) of the semiconductor body (640) includes a layer of front side thin films (625), a layer of polymer fluidics (620), and a second reflective layer, according to principles described in relation to FIG. 5.

An inkjet nozzle (630) has been formed in the semiconductor body (640) by laser ablation and subsequent, wet-etch processing. As in many possible embodiments, a portion of the second layer of reflective material (615) has been removed to allow the passage of ink or other fluid from the back side (545) through the inkjet nozzle (630) and corresponding front side layers (620, 625).

### Exemplary System

Referring now to FIG. 7, another exemplary system (700) of laser ablation machining is shown. The exemplary system (700) includes a laser tool (755) that provides guided laser beam pulses (745) and an assist material (720). The exemplary system (700) also includes a machinable body (710) having a hard mask oxide layer (715) and a plurality of layers of dielectric materials (760, 765, 770) that together reflect optical energy having a certain wavelength or range of wavelengths.

Those of skill in the art will understand that certain arrangements of dielectric materials having different dielectric constants and/or indices of refraction may be placed together in series to create a passive resonant optical device that will reject passage of certain types of light. Under these principles, the materials used in the layers of dielectric materials (760, 765, 770) may be selected to reject passage of optical energy having the wavelength characteristic of the laser beam pulses (745) emitted from the laser tool (755). In some examples, the layer of dielectric materials (760, 765, 770) may form a quarter-wave stack.

The laser tool (755) is configured to selectively remove material from the machinable body (710) to form a trench (705) in the machinable body (710). By rejecting optical energy having the wavelength characteristic of the laser beam pulses (745) emitted from the laser tool (755), the plurality of layers of dielectric materials (760, 765, 770) protect the hard mask oxide layer (715) and regions of the machinable body (710) not indicated for machining from deflected optical energy (730, 740) from the laser beam pulses (745).

### Exemplary Method

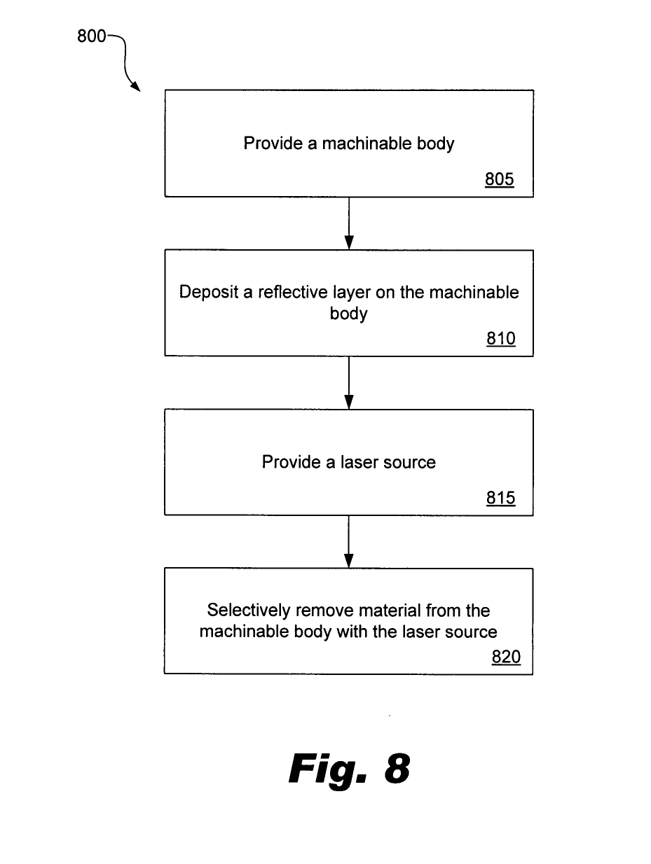

Referring now to FIG. 8, a flowchart illustrating an exemplary method (800) of laser ablation machining is shown. The method (800) includes providing (step 805) a machinable body. The machinable body may be a semiconductor or other material machinable by laser ablation.

The method further includes depositing (step 810) a reflective layer on the machinable body. The step may further include patterning the reflective layer to have openings at those locations where the underlying body is to be subject to ablation without openings elsewhere on the reflective layer.

Examples of suitable reflective materials for use in the reflective layer include, but are not limited to, metals, alloys, metallic oxides, layers of dielectric material, and combinations thereof. The reflective layer may be deposited on the machinable body using sputtering, evaporation, adhesives, or other processes used in the art. Furthermore, the reflective layer may be deposited over an oxide layer on the machinable body. In other embodiments, the reflective layer may be deposited directly on a base material of the machinable body.

The method (800) further includes providing (step 815) a laser source. The specific laser source may be selected depending on the type of material in the machinable body, a desired depth of absorption into the material of the machinable body, and other variables. Additionally, an assist material source may be provided. Examples of suitable assist materials include, but are not limited to, water, air, noble gases, other gases, other liquids, and combination thereof.

The method (800) may further include steps of designating a portion of the machinable body from which it is desired that material be removed. Material from the machinable body may be selectively removed (step 820) from this portion of the machinable body with the laser source. The laser source may be configured to shine a laser beam or laser beam pulses on the portion of the machinable body from which it is desired that material be removed.

In some embodiments, the material may be removed by the laser source on one the same side of the machinable body upon which the reflective layer was deposited (step 810). In other embodiments, the reflective material may be deposited (step 810) on one side of the machinable body, while material is removed (step 820) from another side of the machinable body with the laser source.

The preceding description has been presented to illustrate and describe embodiments and examples of the principles described. This description is not intended to be exhaustive or to limit these principles to any precise form disclosed. Many modifications and variations are possible in light of the above teaching.

What is claimed is:

1. A method of ablation, said method comprising providing a first material on a machinable body that reflects or absorbs energy from an ablation beam so as to limit ablation of said machinable body to a desired area.

2. The method of claim 1, further comprising patterning said first material to include openings exposing a surface of said machinable body where ablation is to occur.

3. The method of claim 1, further comprising using said first material to limit a depth into said machinable body to which said ablation beam may cut.

4. The method of claim 1, further comprising applying a steam of assist material to remove material ablated from said machinable body, wherein said first material prevents energy of said ablation beam deflected by said assist material from ablating unintended portions of said machinable body.

5. The method of claim 1, further comprising applying a laser beam as said ablation beam.

6. The method of claim 1, wherein said first material comprises a reflective layer selected from the group consisting of: metals, alloys, metallic oxides, layers of dielectric material, and combinations thereof.

7. The method of claim 1, wherein said first material comprises a stack of dielectric layers.

8. The method of claim 1, further comprising forming a thermal inkjet die by using said ablation beam to ablate a machinable body comprising a semiconductor so as to form an inkjet nozzle.

9. A system for ablation, comprising:
a machinable body;
an ablation beam source configured to selectively remove material from said machinable body; and
a layer of material on said machinable body that is configured to protect portions of said machinable body from unintended ablation by said ablation beam.

10. The system of claim 9, further comprising an assist material source configured to direct an assist material toward an area of said machinable body where ablation is occurring.

11. The system of claim 9, wherein said layer of material comprises a reflective material that reflects energy of said ablation beam.

12. The system of claim 11, wherein said layer of reflective material is patterned to include openings where ablation is to occur.

13. The system of claim 9, wherein said layer of material absorbs energy of said ablation beam.

14. The system of claim 13, wherein said layer of material comprises a series of dielectric layers configured to absorb energy of said ablation beam.

15. The system of claim 9, wherein said ablation beam source comprises a laser beam source.

16. The system of claim 9, wherein said machinable body comprises a thermal inkjet die.

17. The system of claim 9, wherein said layer of material is disposed on a second side of said machinable body opposite a first side at which said ablation begins.

18. A system for ablation, comprising:
a machinable body;
an ablation beam source configured to selectively remove material from said machinable body; and
means disposed on said machinable body for protecting portions of said machinable body from unintended ablation by said ablation beam.

19. The system of claim 18, wherein said means comprise a reflective material for reflecting energy of said ablation beam.

20. The system of claim 18, wherein said means comprise means for absorbing energy of said ablation beam.
